(19) United States
(12) Patent Application Publication
(10) Pub. No.: US 2008/0156161 A1
(43) Pub. Date: Jul. 3, 2008

(54) Positioning device for a saw blade elevating platform of a wood sawing machine

(75) Inventor: Tian-Wang Wang, Taichung Hsien (TW)

Correspondence Address: Wang Tian-Wang, P.O. Box 44 - 2049, Taipei, 10668, omitted

(73) Assignee: Mao Shan Machinery Co., Industrial Co., Ltd.

(21) Appl. No.: 11/646,361

(22) Filed: Dec. 28, 2006

(51) Int. Cl. B23D 45/06; B23D 45/00

(52) U.S. Cl. 83/477.1; 83/477

(57) ABSTRACT

The invention provides a positioning device for a saw blade elevating platform of a wood sawing machine. More specifically, when a transmission base for controlling a saw blade to elevate in the wood sawing machine is elevated to and positioned at a predetermined position, a predetermined pressing bar disposed in a guiding seat of a mounting seat, at which the elevating platform is located, is pressed by external screws to force the elevating platform to be positioned at a set position. Thus, the saw blade, which is rotated at the high rotating speed and is applied with a high reaction force, can be held absolutely stable, and the operating stability and the precision can be greatly enhanced.

### BACKGROUND OF THE INVENTION

(1) Field of the Invention

The invention relates to a positioning device for a saw blade elevating platform of a wood sawing machine, and more particularly to a positioning device using a pressing bar disposed in a guiding seat of a saw blade elevating platform to press and position the elevating platform when a saw blade is elevated to an operating position so that a precise and stable sawing operation at the set position can be ensured.

(2) Description of the Prior Art

In a conventional wood sawing machine, a saw blade thereof is slantingly elevated by way of pivotal swinging. Thus, the operation is complicated, and the manufacturing cost is increased due to the huge size of the machine. Thus, the present inventor has improved the drawbacks and disclosed a wood sawing machine in U.S. patent application Ser. No. 11/432324. The main feature thereof is to modify the pivotal swinging elevating operation into a linear elevating operation so that the operation steps and time in the elevating operations can be greatly improved, and the weight and the manufacturing cost of the machine can be effectively reduced when the capacity of the overall machine is greatly reduced.

However, after the machine is continuously used for a long time, the saw blade cannot be held absolutely stable and may slightly shake due to the strong reaction force, which is generated when the saw blade is elevated to the sawing position to saw the wood at the high rotating speed. Thus, the lifetime of the saw blade is shortened, and defects may be caused in the wood sawing operation, which is getting more and more precise. Thus, the above-mentioned wood sawing machine still has to be improved.

### SUMMARY OF THE INVENTION

In order to eliminate the drawbacks in the above-mentioned wood sawing machine, the inventor has improved the above-mentioned wood sawing machine and thus designed the wood sawing machine of the invention. The main object is to dispose a longitudinal pressing bar in advance on an internal side of a guiding seat of a mounting seat combined with a saw blade elevating platform. Thus, when the saw blade elevating platform is elevated to and positioned at a predetermined position, an external force is provided to press the pressing bar against a base of the elevating platform. Thus, the strong reaction force generated when the saw blade is sawing can be stably absorbed by the overall base without any shaking phenomenon.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is an exterior illustration showing a wood sawing machine of the invention.

FIG. 2 is a schematic illustration showing internal mechanisms of the wood sawing machine of the invention.

FIG. 3 is another schematic illustration showing the internal mechanisms of the wood sawing machine of the invention.

FIG. 4 is a schematic illustration showing a combination of an elevating platform and a mounting seat according to the invention.

FIG. 5 is another schematic illustration showing a combination of the elevating platform and the mounting seat according to the invention.

### DETAILED DESCRIPTION OF THE PREFERRED EMBODIMENTS

The structure of the invention will be described with reference to the accompanying drawings.

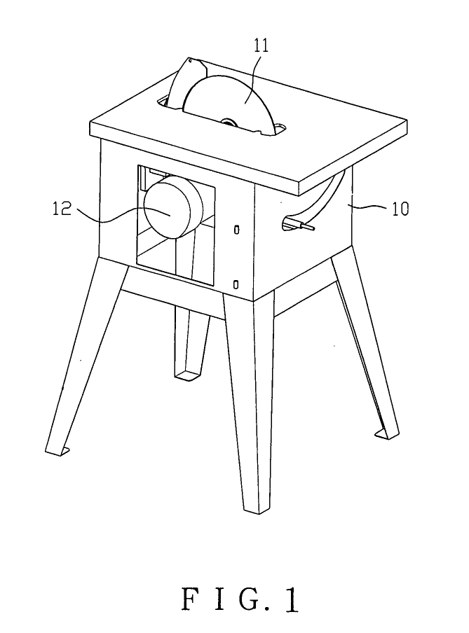

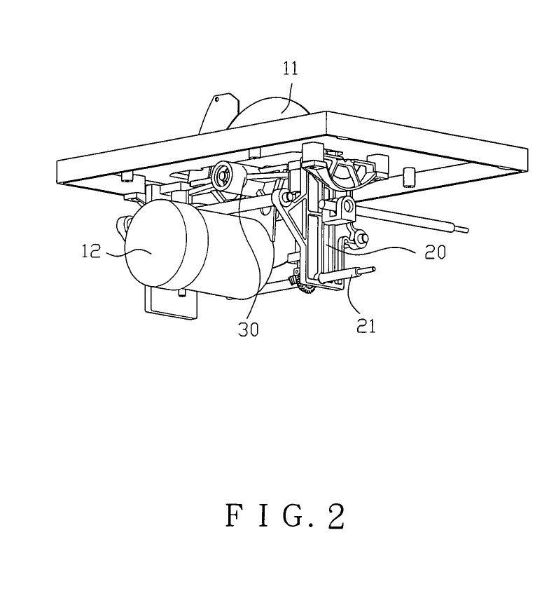

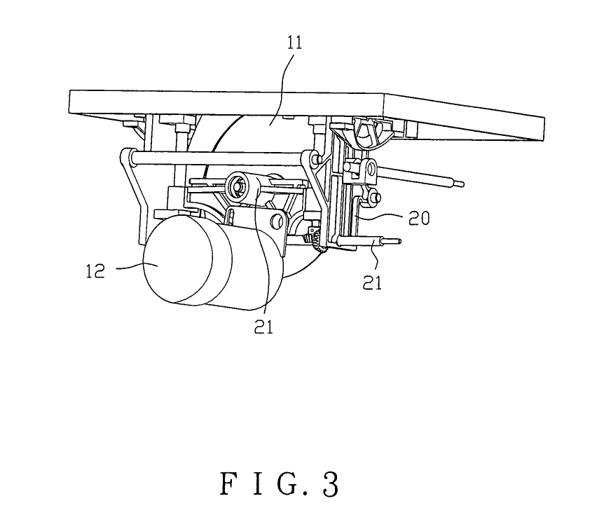

As shown in FIGS. 1 to 3, a saw blade 11 on the top of a wood sawing machine 10 of FIG. 1 is rotated by an external motor 12. In order to achieve the security in use, a mounting seat 20 and a saw blade elevating platform 30 have to be provided, as shown in FIGS. 2 and 3, so that the elevating platform 30 controlled by an operating level 21 can elevate the saw blade 11 and the motor 12 to a sawing state of FIG. 2, and lower the saw blade 11 down to the table to become a safe state of FIG. 3 when the machine is not used within a range restricted by the mounting seat 20.

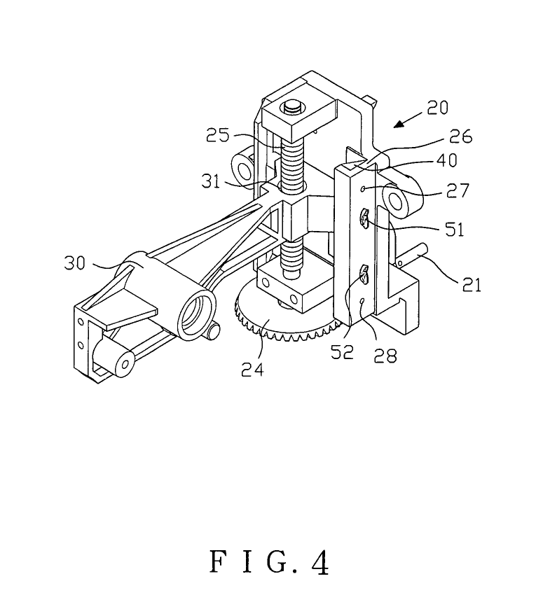

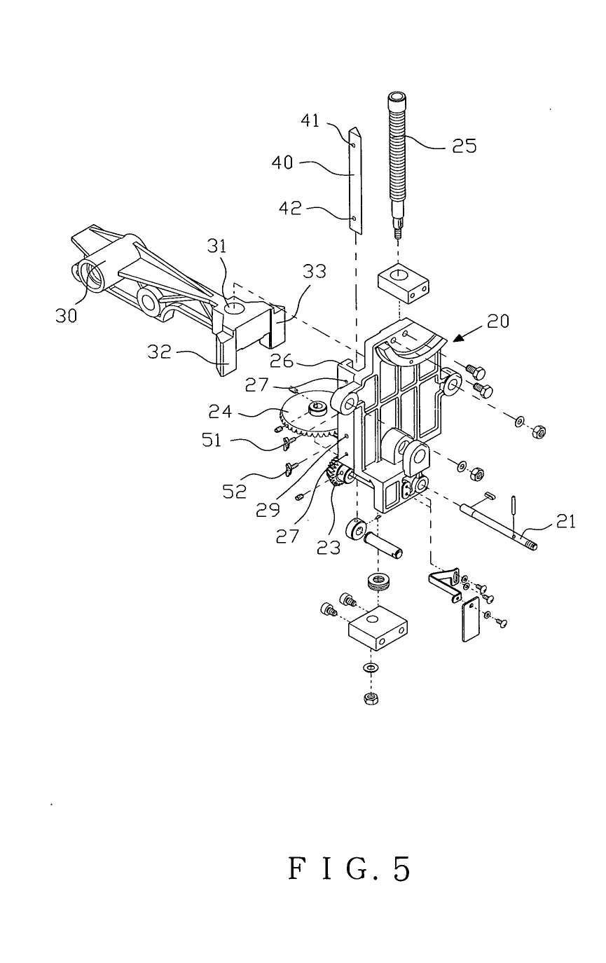

Next, as shown in FIGS. 4 and 5, the operating level 21 below the mounting seat 20 of the invention controls two gears 23 and 24 to rotate clockwise or counterclockwise so as to rotate a screw rod 25. Thus, when the screw rod 25 is rotated, the elevating platform can be lifted up or lowered down to lift up or lower down the outside saw blade (not shown in this drawing) through a screw hole 31 of the elevating platform 30 combined with the screw rod 25. In this case, bases 32 and 33 on two sides of the tail end of the elevating platform 30 are fit into a guiding seat 26 formed on an internal side of the mounting seat 20 so that the elevating platform 30 may be lifted up and lowered down with the rotation of the screw rod 25. Meanwhile, a longitudinal pressing bar 40 having a front side that may be completely attached to the external side of the base 32 is disposed on an internal side of the guiding seat 26 in advance. The pressing bar 40 is properly positioned in the guiding seat 26 by screws passing through two positioning holes 27 and 28 and screwed into two screw holes 41 and 42 so that the pressing bar 40 cannot be moved with the up and down movement of the base 32. When the elevating platform 30 and the saw blade are lifted to the correct sawing position, external screws 51 and 52 may be provided to screw into through holes 29, which are formed on the external side of the guiding seat 26, to tightly press the pressing bar 40 against the base 32. Thus, the overall elevating platform 30 and the saw blade may be held in the stable state during the sawing operation, the high quality and the precision in sawing may be ensured, and the working efficiency of the wood sawing machine may be greatly enhanced.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A positioning device for positioning a saw blade elevating platform of a wood sawing machine, the positioning device comprising:
a mounting seat having a guiding seat formed on an internal side of the mounting seat; and
a longitudinal pressing bar attached to a base of an elevating platform, wherein the longitudinal pressing bar is forced to press against the base of the elevating platform or to release from the base.

2. The device according to claim 1, wherein the longitudinal pressing bar is positioned on an internal side of the guiding seat of the elevating platform in advance.

3. The device according to claim 1, wherein the longitudinal pressing bar has an internal side surface completely attached to an external side surface of the base of the elevating platform.

4. The device according to claim 1, wherein the longitudinal pressing bar is forced to press against the base of the elevating platform or to release from the base by an external screw disposed on an external side of the guiding seat.
